(19) United States
(12) Patent Application Publication
(10) Pub. No.: US 2006/0279098 A1
(43) Pub. Date: Dec. 14, 2006

(54) Universal finger loop for cellular phones and portable electronic device

(76) Inventors: David Michael Shipley, Brooklyn, NY (US); Nicole Florene Durfee, Brooklyn, NY (US)

Correspondence Address: David M. Shipley, 131 Hall St, #1, Brooklyn, NY, 11205, US

(21) Appl. No.: 11/437,605

(22) Filed: May 18, 2006

Related U.S. Application Data
(60) Provisional application No. 60/682,139, filed on May 18, 2005.

(51) Int. Cl. B65G 7/12

(52) U.S. Cl. 294/25

(57) ABSTRACT

A universal finger loop for cellular phones and portable electronic devices of the type having a flexible loop of appropriate size to be penetrated by a human finger and a means for affixing it to a cellular phone or portable electronic device. The loop is positioned at the top of the back side of the device, where it may be easily and ergonomically penetrated by a device user during device interaction, whereby creating an assisted, secure grip between the user and the device. The finger loop may also comprise a transparent, flexible, or elastic strip to encircle the device body or battery cover; a reusable, adjustable closure that can adapt to different device sizes; or a means for adjusting the size of the loop to fit different fingers.

### FEDERALLY SPONSORED RESEARCH

Not Applicable

### SEQUENCE LISTING OR PROGRAM

Not Applicable

### BACKGROUND—FIELD OF INVENTION

This invention relates generally to cellular phone and portable electronic device accessories, and specifically to an accessory that provides a loop which slips over the finger of the phone or device user.

### BACKGROUND—DESCRIPTION OF PRIOR ART

Commonly, people interact (carry, dial, text message, talk, play video games, listen to music, watch movies, etc.) with cellular phones and portable electronic devices while performing other tasks such as walking, carrying objects, looking for things, etc. Cellular phones and portable electronic devices are expensive and used away from the home, and users are often concerned with dropping, damaging, or losing their devices. Therefore, a loop that attaches the device to the user's finger during device interaction could prevent damage and/or loss of cellular phones and portable electronic devices.

It has been observed that users generally interact with cellular phones and portable electronic devices in a similar manner. That is, they hold the main body of the device within their palm and then place their index finger over the upper half of the device. A need exists for an invention that provides a positioned loop for the index finger to penetrate and engage securely upon cellular phones and portable electronic devices, and the loop should be positioned approximately where users generally place their index fingers while holding devices.

Cellular phones and portable electronic devices are currently available in many shapes and sizes. Also, the size of users' fingers may vary. Therefore, a design for a universal finger loop should be adaptable to different devices and models of devices and should accommodate different finger sizes.

While many accessories exist for cellular phones and portable electronic devices, none of them include a finger loop. All of the cases and clips currently on the market affix the device to the user's clothing, bag, wrist, or neck, rather than to their finger, where it can be held most securely. Still, many users enjoy existing accessories for storing their devices, and a finger loop would ideally be compatible with these other accessories.

### OBJECTS AND ADVANTAGES

Several objects and advantages of my invention are:

(a) To provide a universal finger loop which affixes cellular phones and portable electronic devices to users' fingers during device interaction.

(b) To provide a universal finger loop which solves the obvious concern of dropping, damaging, or losing one's cellular phone or portable electronic device by facilitating a secure grip during interaction.

(c) To provide a universal finger loop which is ergonomic, and makes interacting with cellular phones and portable electronic devices secure and comfortable.

(d) To provide a universal finger loop which is small and compatible with various cellular phones and portable electronic devices and their accessories.

(e) To provide a universal finger loop which facilitates prolonged device interaction, allowing users to securely hold their device in the palm of one hand while doing time-consuming tasks or tasks which require more button pushing, including but not limited to watching a movie, text messaging, listening to music, or playing a video game.

(f) To provide a universal finger loop which facilitates multitasking, allowing users to securely hold their device in the palm of one hand while performing other tasks including but not limited to looking for something in a bag, writing something down, interacting with another device, interacting with a human.

(e) Further objects and advantages are to provide a universal finger loop for which demand will increase with the trend of increasing cellular phone and portable electronic device usage among all age groups, races, and socioeconomic classes. Still further objects and advantages will become apparent from a consideration of the ensuing descriptions and drawings.

### SUMMARY

In accordance with the present invention, a universal finger loop for cellular phones and portable electronic devices comprises a loop which can be affixed to the device in an ergonomic position. The preferred embodiment also includes a flexible or elastic strip of predetermined size and a hook-and-loop or adhesive fastener. Alternative embodiments may also include a molded plastic part (cord lock) which encases a spring or springs that hold the loop in the user's adjusted setting.

### DRAWINGS

Drawing Figures

FIG. 1 shows a universal finger loop open and assembled with finger loop up.

FIG. 2 shows a universal finger loop open and assembled with finger loop down.

FIG. 3 shows side view of universal finger loop open and assembled.

FIG. 4 shows a universal finger loop encircled around phone/device body or battery cover and attached around back side of device.

FIG. 5 shows a universal finger loop encircled and attached around display face of cellular phone.

FIG. 6a shows a universal finger loop open and assembled with transparent strip, adhesive, and flexible loop.

FIG. 6b shows a universal finger loop open and assembled with screen, magnets, and flexible loop.

FIG. 6c shows a universal finger loop open and assembled with flexible strip, cord lock, and flexible loop.

FIG. 6d shows a universal finger loop open and assembled with transparent strip, hook-and-eye, and flexible loop.

FIG. 7 shows front view of a universal finger loop as one flexible (elastic or rubber) molded band and finger loop piece.

FIG. 8 shows rear view of a universal finger loop as a flexible (elastic or rubber) molded band and finger loop piece with built-in cord lock.

FIG. 9 shows a universal finger loop as rigid plastic piece.

FIG. 10 shows a universal finger loop positioned and affixed to back side of phone.

FIG. 11 shows a universal finger loop positioned and threaded through a cord lock affixed to back side of phone.

### REFERENCE NUMERALS IN DRAWINGS

10 transparent strip
12 hook-and-loop fastener
13 adhesive
14 flexible loop
15 screen
17 magnet
18 flexible (not transparent) strip
19 cord lock
20 hook-and-eye closure
22 flexible or elastic band and loop
24 flexible or elastic band
26 rigid piece with loop

### DETAILED DESCRIPTION

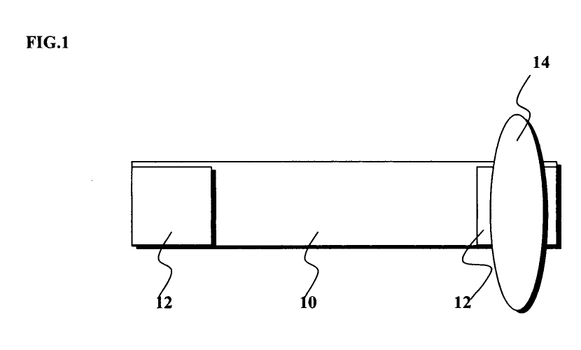

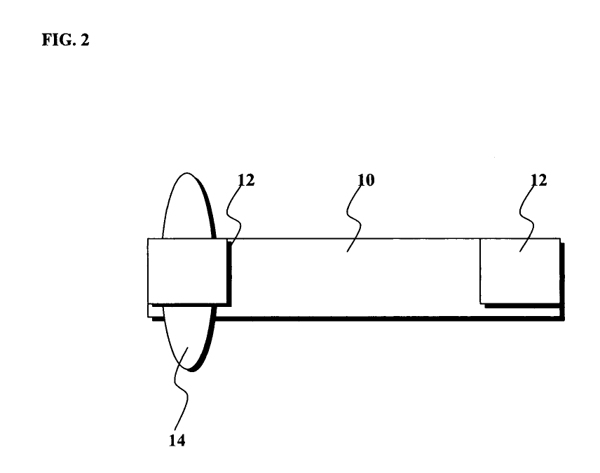

### Description—FIGS. 1 and 2 Preferred Embodiment

A preferred embodiment of the present invention of a universal finger loop for cellular phones and portable electronic devices is illustrated open and assembled with finger loop up in FIG. 1. A piece of hook-and-loop fastener 12 is attached at one end of a transparent strip 10. A flexible loop 14 plus another piece of hook-and-loop fastener 12 are attached to the opposite side of the other end of said transparent strip 10.

In FIG. 2 a universal finger loop is open and assembled with finger loop down. A flexible loop 14 plus a piece of hook-and-loop fastener 12 are attached at one end of a transparent strip 10. Another piece of hook-and-loop fastener 12 is attached to the opposite side of the other end of said transparent strip 10.

In FIG. 3 (side view) a universal finger loop is open and assembled. A piece of hook-and-loop fastener 12 is attached to the bottom left side of a transparent strip 10. A flexible loop 14 plus another piece of hook-and-loop fastener 12 are attached to the top right side of said transparent strip 10, in a manner such that said flexible loop 14 is sandwiched between hook-and-loop fastener 12 and transparent strip 10.

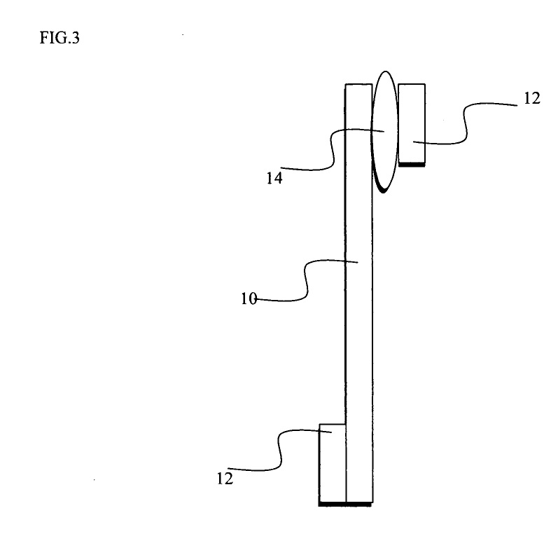

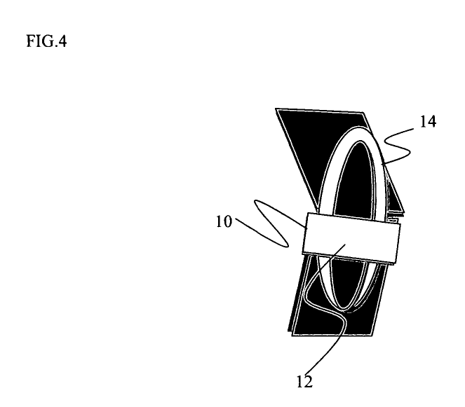

In FIG. 4 a universal finger loop is assembled and encircled around the body or battery cover of a cellular phone or portable electronic device. A piece of hook-and-loop fastener 12 is attached at one end of a transparent strip 10. A flexible loop 14 plus another piece of hook-and-loop fastener 12 are attached to the opposite side of the other end of said transparent strip 10. Said transparent strip 10 is encircled around the phone or device body or battery cover, and the two pieces of said hook-and-loop fastener 12 are interlocked, thus affixing said flexible loop 14 on the back side of the device in a position such that it may be easily penetrated by the finger of a phone or device user, creating an assisted grip between the user and the device.

In FIG. 5 a universal finger loop is assembled and encircled around the body or battery cover of a cellular phone or portable electronic device. A piece of hook-and-loop fastener 12 is attached at one end of a transparent strip 10. A flexible loop 14 plus another piece of hook-and-loop fastener 12 are attached to the opposite side of the other end of said transparent strip 10. The two said pieces of hook-and-loop fastener 12 are interlocked at the back side of the device, and said transparent strip 10 is encircled around the device such that the buttons and/or screens of the device may be seen and manipulated through said transparent strip 10.

Theory of Operation

While I believe users interact with cellular phones and portable electronic devices in a similar manner, that is, they hold the main body of the device within their palm and then place their index finger over the upper half of the device, I don't wish to be bound by this.

Operations—FIGS. 1-5

The manner of using an assembled universal finger loop for cellular phones and portable electronic devices is to first place flexible loop 14 in the desired position. Second, hold flexible loop 14 plus hook-and-loop fastener 12, which are attached to one end of transparent strip 10 upon the back side of the device in the desired position. Next, encircle said transparent strip 10 around the device body or battery cover so that the two pieces of said hook-and-loop fastener 12 are facing each other. Then, interlock the two pieces of said hook-and-loop fastener 12 at the back side of the device or battery cover. If encircling around the battery cover, replace the battery cover onto the device after interlocking the two pieces of said hook-and-loop fastener 12. Finally, tighten and make adjustments so the universal finger loop fits snugly on the device and the user's finger.

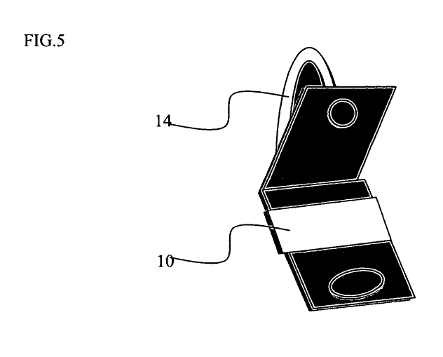

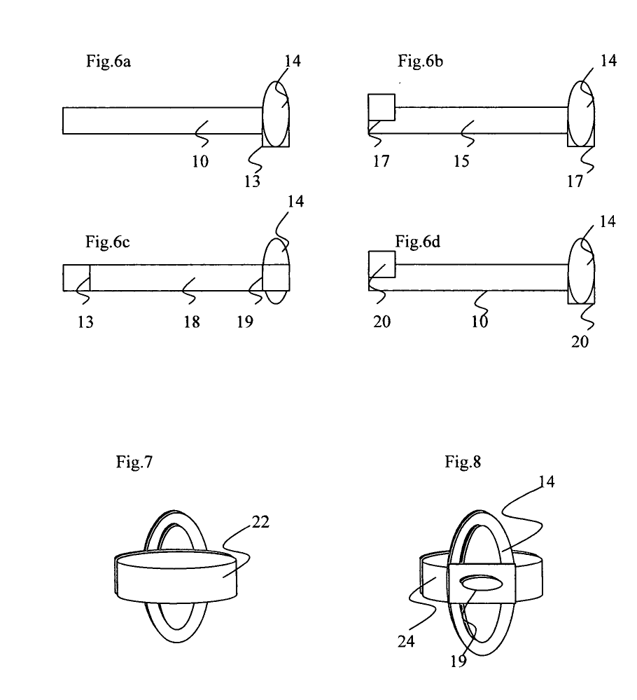

### Additional Embodiments—FIGS. 6a-6d

Additional embodiments are shown in FIGS. 6a-6d. In each case a universal finger loop for cellular phones and portable electronic devices is illustrated open and assembled. FIG. 6a shows a universal finger loop comprising of adhesive 13 replacing hook-and-loop fastener 12; FIG. 6b shows a screen 15 replacing transparent strip 10, and magnets 17 replacing hook-and-loop fastener 12; FIG. 6c shows a flexible strip (not transparent) replacing transparent strip 10, and the addition of a cord lock 19 attached with adhesive 13; FIG. 6d shows a hook-and-eye closure 20 replacing hook-and-loop fastener 12.

Operations—FIGS. 6a-6d

The manner of using an assembled universal finger loop for cellular phones and portable electronic devices as shown in FIG. 6a-d is similar to that used for a universal finger loop as shown in FIG. 1-5. First place flexible loop 14 in the desired position. Second, hold flexible loop 14 plus adhesive 13, magnet 17, cord lock 19, or hook-and-eye closure 20, which are attached to one end of transparent strip 10, screen 15, or flexible (not transparent) strip 18 upon the back side of the device in the desired position. Next, encircle said transparent strip 10, screen 15, or flexible (not transparent) strip 18 around the device body or battery cover so that the adhesive 13, magnet 17, or hook-and-eye closure 20 is over said flexible loop 14. Then, adhere or interlock the adhesive 13, magnet 17, or hook-and-eye closure 20 at the back side of the device or battery cover. If encircling around the battery cover, replace the battery cover onto the device after adhering closure. Finally, tighten and make adjustments so the universal finger loop fits snugly on the device and the user's finger. In FIG. 6c, cord lock 19 is added to make the flexible loop adjustable to different finger sizes.

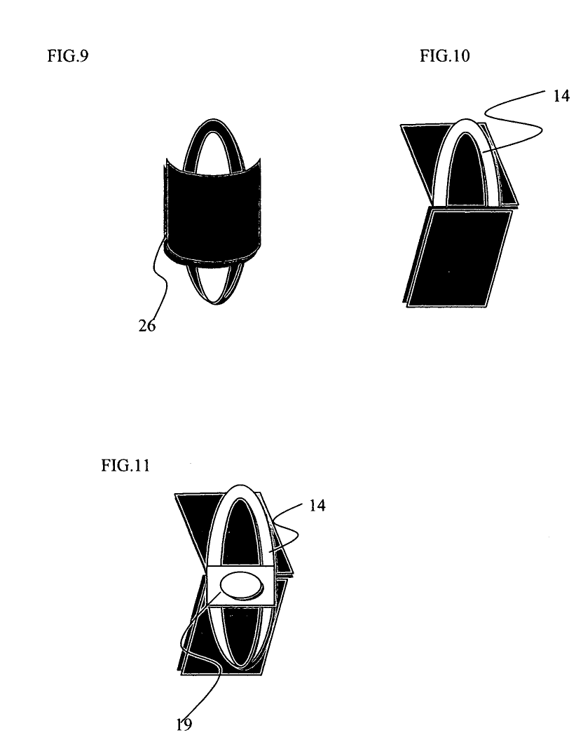

### Alternative Embodiments—FIG. 7, FIG. 8, FIG. 9, FIG. 10, and FIG. 11

FIG. 7-11 show alternative embodiments of a universal finger loop for cellular phones and portable electronic devices comprising rubber, metal, and/or plastic. FIG. 7 (front view) shows a universal finger loop comprising flexible or elastic band and loop 22 which may slide over cellular phones and portable electronic devices or battery covers. FIG. 8 (rear view) shows a universal finger loop comprising flexible or elastic band and loop 22 with built-in cord lock 19 which may slide over cellular phones and portable electronic devices or battery covers. FIG. 9 shows a universal finger loop comprising one rigid piece with loop 26 shaped to snap onto cellular phones and portable electronic devices. FIG. 10 shows a universal finger loop, comprising finger loop 14 adhered on a cellular phone or portable electronic device. FIG. 11 shows a universal finger loop comprising said finger loop 14 threaded through cord lock 19 adhered on cellular phone.

Operations—FIGS. 6a-6d, FIG. 7, FIG. 8, FIG. 9, FIG. 10, and FIG. 11

The manner of using a universal finger loop for cellular phones and portable electronic devices as shown in FIG. 7 is to slide flexible or elastic band and loop 22 over cellular phone, portable electronic device, or battery cover so that the loop portion is in the desired position. In FIG. 8, slide flexible or elastic band 24 over cellular phone, portable electronic device, or battery cover. Then thread flexible loop 14 through cord lock 19 so that it is in the desired position and may be adjusted to comfortably accommodate the user's finger. In FIG. 9 snap rigid piece with loop 26 onto back side of cellular phone or portable electronic device so the loop portion is in the desired position. In FIG. 10, attach flexible loop 14 onto cellular phone or portable electronic device with any adhesive or closure or by any method of threading the loop through openings in the device body, hooking the loop to device parts, or otherwise affixing flexible loop 14 to the device in the desired position. In FIG. 11, thread flexible loop 14 through cord lock 19 and affix cord lock 19 to cellular phone or portable electronic device in the desired position with any adhesive or closure.

Advantages

From the description above, several advantages of a universal finger loop for cellular phones and portable electronic devices become evident:

(a) Affixing a flexible loop to cellular phones and portable electronic devices allows an opening through which a device user can ergonomically insert his/her finger during device interaction. This creates an assisted, secure grip between the device user and the device, minimizing the risk of dropping, damaging, or losing the device.

(b) Positioning the flexible loop at the top of the back side of a cellular phone or portable electronic device places said loop in the path of a device user's index finger, assuming the device user follows the theory of operation outlined above. This makes penetrating the loop ergonomic for the device user. Therefore, maintaining a grip on the device with one's index finger through said loop is comfortable, easy, and secure for the device user.

(c) Most of the embodiments of this invention include a removable, reusable, and adjustable closure. This allows the universal finger loop to adapt to different devices and models of devices. This also allows the universal finger loop to be easily removed from and reattached to the device and allows it to be moved from one device to another. Therefore, even if a universal finger loop owner replaces his/her device, he/she can still use his/her finger loop.

(d) Most of the embodiments of this invention are small, and therefore likely to be compatible with other cellular phone and portable electronic device accessories.

(e) The finger loop is positioned such that gripping the device with one's finger through the loop creates an assisted, secure grip. This grip can be maintained with minimal effort from one hand, which makes performing time-consuming device interactions and tasks that require more button-pushing, such as watching a movie, text messaging, listening to music, or playing a video game, more practical.

(f) The advantage described in (e) above also frees a device user's other fingers and hand to perform tasks including but not limited to looking for something in a bag, writing something down, interacting with another device, or interacting with a human while still comfortably holding the device.

(g) The addition of a cord lock to the universal finger loop allows the loop to be adjusted to fit different finger sizes.

(h) Many embodiments of this invention include a strip or band that may encircle the device body and a reusable, adjustable closure that can accommodate various cellular phones, portable electronic devices, their accessories, and battery covers with increased compatibility and adaptability.

### CONCLUSION, RAMIFICATION, AND SCOPE OF INVENTION

Thus the reader will see that the invention of a universal finger loop for cellular phones and portable electronic devices provides compatible, reliable, ergonomically positioned finger loop through which users may insert their index finger during device interaction. This creates an assisted, secure grip between the user and the device, and solves the obvious concern of dropping, damaging, or losing the device during interaction. This assisted grip may be maintained easily with one hand or even one finger. Therefore, the grip is comfortable for prolonged device interaction and allows the user to perform other tasks including but not limited to looking for something in a bag, writing something down, interacting with another device, or interacting with a human. Additionally, this invention will continue to have a large market of possible consumers, because the trend of cellular phone and portable electronic device usage is increasing among all age groups, races, and socioeconomic classes.

While my above description contains many specifications, these should not be construed as limitations on the scope of the invention, but rather as an exemplification of one preferred embodiment thereof. Many other variations are possible. For example, a screen, flexible, or elastic strip may replace a transparent strip; and removable and/or permanent adhesive, magnet, or hook-and-eye closure may replace a hook-and-loop fastener. A flexible loop may be threaded through a cord lock and affixed onto any combination of the above embodiments. The flexible loop may be made of elastic, metal, plastic, rubber, strong, sturdy, colored, translucent, transparent, or any other possible materials. The flexible loop may be an arch, circular, cusp, elliptical, helical, diamond-shape, oblong, oval, rectangular, square, and/or triangular. The method connection and/or association with adjacent elements may be different. The finger loop may be of one whole flexible, elastic or rigid part in connection to a cellular phone or portable electronic device, or may comprise interlocking or interwoven part.

Accordingly, the scope of the invention should be determined not by the embodiments illustrated, but by the appending claims and their legal equivalents.

I claim:

1. A universal finger loop for cellular phones and portable electronic devices, comprising:
a.) a loop of sufficient size to be penetrated by a human finger
b.) a means for affixing said loop to a cellular phone or portable electronic device in a position such that a device user may ergonomically penetrate said loop with his/her finger,
whereby creating an assisted, secure grip between the user and the device.
